(19) United States
(12) Patent Application Publication
(10) Pub. No.: US 2007/0092621 A1
(43) Pub. Date: Apr. 26, 2007

(54) Method and apparatus for manufacturing noodles for cold noodle dish through extrusion

(75) Inventors: Kenny Sohn, Yongin-si (KR); Johannan Hur, Incheon (KR); Hyuk-hwa Kim, Incheon (KR)

Correspondence Address: Medlen & Carroll, LLP, Suite 350, 101 Howard Street, San Francisco, CA, 94105, US

(73) Assignee: CJ Corp., Seoul (KR)

(21) Appl. No.: 11/519,249

(22) Filed: Sep. 12, 2006

(30) Foreign Application Priority Data
Sep. 12, 2005 (KR) 10-2005-0084578

(51) Int. Cl. A23L 1/16

(52) U.S. Cl. 426/557

(57) ABSTRACT

Disclosed herein are a method of and an apparatus for manufacturing cold noodles exhibiting the thin and chewy texture unique to fresh noodles, in a continuous manner through extrusion, by which the extruded noodle strips can be prevented from undergoing puffing, weight deviation and agglomeration, so as to increase the productivity. The cold noodles can be manufactured by kneading a formulated material with water to afford dough having a water content of 30˜45%; using an extruder to extrude the dough into individually separated strips through a die maintained at a low temperature, said dough being heated to a temperature sufficiently high to induce gelatination therein by frictional force attributable to shearing force of the extruder; and cutting the strips to a predetermined length and packaging the strips.

### BACKGROUND OF THE INVENTION

1. Field of the Invention The present invention relates to a method and an apparatus for manufacturing noodles. More particularly, the present invention relates to a method and an apparatus for manufacturing noodles through extrusion on a large scale.

2. Description of the Related Art

Among Korean traditional foods, there is a so-called “ice or cold noodle dish” which is cooled on ice before being eaten. Traditionally, the noodles used for the food are prepared from cereal powder, such as buckwheat, potato starch or sweet potato starch, rather than wheat flour. For example, the Korean traditional foods Pyongyang cold noodles and Chuncheon noodles are based on buckwheat, and Hamheung cold noodles are prepared mainly from potato starch. All such noodles are very tough and chewy. They are manufactured through extrusion. In detail, a starch mixture or a buckwheat powder is kneaded with hot water into dough which is then extruded through a noodle frame. As soon as they are extruded from the dough, strips of noodles are directly immersed in hot water, thereby conferring a characteristic texture on the noodles (Lee, Chul Ho, Introduction to Korean Sitology, pp. 202-204, 2003).

Since its unit steps, that is, mixing, pulverizing, heating, molding and drying steps, are conducted within a short time period, an extrusion process is effective and economically advantageous compared to other processes. The material within an extruder not only undergoes shearing force according to the rotation of the screw, but also is pressurized according to the control of a die exit. When combined with a heating process, the extrusion process continuously exerts physical force on the material at a high temperature under a high pressure (Harper, Extrusion Cooking, pp 1-16, 1989).

Since the 1930s, an extrusion process has been introduced into labor-intensive industries as a solution to the problem of requiring excessive labor. The extrusion process was first applied as a continuous process in the plastic molding field. Recently, the extrusion process has found a wide range of applications in various industries including food, feedstuff, biotechnology and medicine industries. Since the first use of a single-screw extruder in continuously produced pasta in the mid 1980s, the extrusion process has been systematically applied in the food industry (Harper, Extrusion of Foods, pp. 1-6, 1981). Examples of applications of extrusion in the food field include snacks obtained by swelling cereals, gelatinized starch, texturization of vegetable proteins, pretreatment for oil extraction, pasteurization, transformation of polymeric biomass, and conversion of bean curd dregs into intermediate products (Ryu, Ki Hyoug, Journal of Korean Soybean Society 12(2): 43-48, 1995). However, the extrusion process has not yet been applied to automate the production of Korean traditional cold noodles.

Currently, starch (sweet potato starch, potato starch or tapioca starch) or buckwheat in combination with wheat flour is used as the main material in the preparation of cold noodles. Typically, a mixture of wheat flour and starch or buckwheat is kneaded with water into dough with a water content of 50-60% before extrusion through an extruder 101 shown in FIG. 1. In the extruder, the dough is extruded into strips as a screw 101 rotates. In order to improve the taste of the cold noodles, a barrel 102 is heated to about 150 to 200° C.

The cold noodles molded through the extrusion process are stored at a freezing temperature (−15˜−25° C.) for 24 hours and aged at a refrigerating temperature (5° C.) for an additional 24 hours. Subsequently, strips of the cold noodles are separated from each other by manually rubbing them at room temperature. The freezing and thawing process facilitates the separation of the noodle strips.

Currently, most of the processes, from the separation of noodle strips to weighing and packaging, are conducted by hand. Thus, this labor-intensive manufacturing method requires 48 hours or longer for completing a series of processes of freezing, thawing, and packaging cold noodles, suffering from the disadvantage of being low in productivity.

### SUMMARY OF THE INVENTION

Leading to the present invention, intensive study on the manufacture of cold noodles on a large scale in an automatic process, conducted by the present inventors, resulted in the finding that, when extruded, noodle dough can be heated to a sufficiently high temperature to cause gelatination therein if truncated conical screws are used to exert a shearing force on the dough in the extrusion process, and that the noodle dough can be molded into strips as thin as 1 mm or less, which not only exhibit the texture and taste unique to the fresh cold noodles, but also are readily separable so as to eliminate the requirement of freezing and thawing processes, which are required in the conventional method.

Accordingly, the present invention has been made aiming to solve the problems occurring in the labor-intensive production methods, and one object of the present invention is to provide a method of and an apparatus for manufacturing cold noodles in a continuous manner through extrusion, by which the extruded noodle strips can be prevented from undergoing puffing, weight deviation and conglomeration so as to increase the productivity thereof.

It is another object of the present invention to provide a method of and an apparatus for manufacturing cold noodles which exhibit a thin and chewy texture peculiar to fresh noodles.

In order to accomplish the above objects, one aspect of the present invention provides a method of manufacturing cold noodles, comprising: kneading a formulated material with water to afford dough having a water content of 30˜45%; extruding the dough into individually separated strips through a die maintained at a low temperature using an extruder, the dough being heated to such a high temperature that gelatination is induced therein by frictional force attributed to a shearing force of the extruder; and cutting the strips to a predetermined length and packaging the strips.

In the method, preferably, the die is maintained at 50° C. or lower and the dough is heated to a temperature range from 50 to 150° C.

The formulated material may be selected from a group consisting of wheat flour, buckwheat, starch, black rice powder, acorn powder, salt, and combinations thereof.

In accordance with another aspect of the present invention, the above objects can be accomplished through the provision of an apparatus for manufacturing cold noodles, comprising: a dough feeder including a plurality of carrying screws functioning to carry noodle dough having a water content of 30˜45%; and an extruder including: a cylindrical barrel, communicating through a passage with the dough feeder; an extruding screw which rotates within the barrel, functioning to move forward the dough introduced through the passage within the barrel and to heat the dough to a sufficiently high temperature to induce gelatination therein by generating internal frictional force attributable to shearing force of the extruding screw on the dough; and an extruding die, maintained at the gelatination temperature and equipped with a plurality of holes for molding the dough into individually separated strips therethrough.

In a preferable modification, the extruding screw comprises a plurality of truncated conical screws having larger diameters at sides nearer an exit of the extruder, and a plurality of circular screws, installed near the exit within the barrel, for carrying the dough.

Preferably, the extruding screw rotates at a speed from 50 to 150 rpm to heat the dough to a temperature ranging from 50° C. to 150° C.

In the apparatus, each of the holes is 1 mm or less in diameter and the extruding die is maintained at 50° C.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing a conventional extruding apparatus for manufacturing cold noodles;

FIG. 2 is a schematic view showing an extruding apparatus for manufacturing cold noodles in accordance with the present invention; and

FIG. 3 is a flow chart illustrating the processes of manufacturing cold noodles in accordance with the present invention.

### DESCRIPTION OF THE PREFERRED EMBODIMENTS

Below, a detailed description will be given of the present invention with reference to the accompanying drawings. In accordance with an embodiment of the present invention, a method of manufacturing cold noodles through extrusion is provided.

Referring to FIG. 2, an extrusion molding apparatus suitable for use in the method of manufacturing of cold noodles in accordance with the present invention is schematically shown.

As shown in FIG. 2, the extrusion molding apparatus 1 for manufacturing cold noodles comprises a dough feeder 2 for carrying dough, and an extruder 3 for extruding the dough fed from the feeder 2 into noodles. The dough for cold noodles is formulated from a material selected from among wheat flour, buckwheat powder, sweet potato starch, black rice powder, acorn powder, salt, and combinations thereof, and water in an amount that gives a water content of 30˜45% to the dough. After being formulated from predetermined amounts of the ingredients, the dough is introduced through an inlet 4 into the dough feeder 2 and then carried to the extruder 3 by a plurality of carrying screws driven by a motor.

The dough is moved from the dough feeder 2 through a passage 7 to the extruder 3. As shown in FIG. 2, the extruder 3 comprises a cylindrical barrel 8, an extruding screw 9 rotating within the barrel 8, and a die 10 having a plurality of holes 1 mm or less in diameter, through which the dough is molded into noodles. During the extrusion process, the extruding screw 9 rotates at a speed of 50˜150 rpm and the extruder exit, that is, the die 10, is preferably maintained at a temperature of 50° C. or lower.

The extruding screw 9, as shown in FIG. 2, includes a plurality of truncated conical screws 9a which have larger diameters at sides nearer the exit, and a plurality of circular screws 9b, installed near the exit within the barrel, for carrying the dough. Once it arrives at the extruder 3 through the passage 7 from the dough feeder 2, the dough is extruded by the plurality of truncated conical screws 9a while the shearing force of the truncated conical screws 9a causes high frictional force in the dough.

While being extruded, the dough is heated by the frictional force attributable to the shearing force of the screws 9a. In the apparatus of the present invention, the temperature of the dough is increased sufficiently to induce gelatinization, that is, to a temperature ranging from 50° C. up to 150° C. In contrast to conventional extruders, accordingly, the apparatus of the present invention can achieve a desired texture and taste in the finally produced noodles even though the temperature of the barrel 8 and the water content of the dough are maintained at low levels. In addition, while exiting of the extruder through the extruding die 10 maintained at a temperature of 50° C. or lower, the strips of the noodle are cooled and thus can be readily separated from each other.

A better understanding of the present invention may be realized by reading the following examples, which are set forth to illustrate, but are not to be construed to limit the resent invention.

### EXAMPLE 1

### Preparation of Cold Noodle Through Extrusion

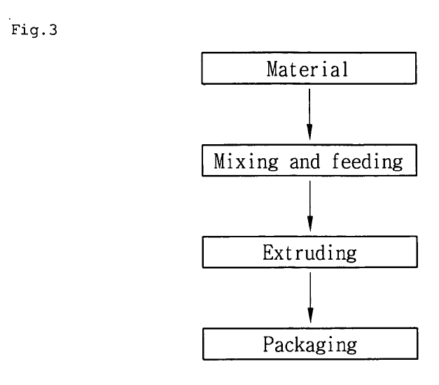

A formulation material comprising wheat flour, buckwheat, sweet potato starch, black rice powder, acorn powder, salts, and combinations thereof was kneaded with water into dough having a water content of 30˜45%. Using the apparatus shown in FIG. 2, the dough was extruded in a continuous manner to afford noodles. The extruding die 10, serving as an exit, was maintained at 50° C., and the rotation speed of the extruding screw 9 was set at 50˜150 rpm. Thin strips 1 mm thick or thinner thus obtained were cut to a length of 30˜50 cm, followed by packing the noodles in an envelope. The process described in Example 1 is schematically illustrated in FIG. 3.

### COMPARATIVE EXAMPLE 1

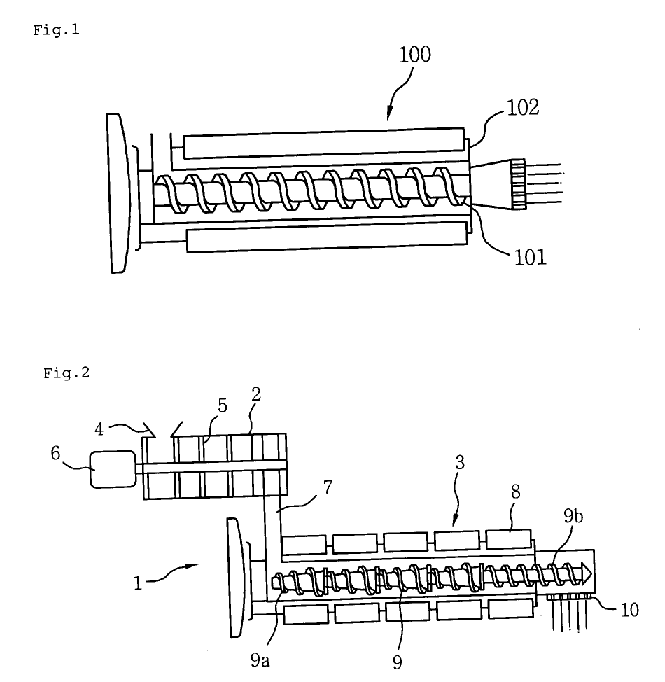

According to a conventional method, a mixture of wheat flour, starch and buckwheat was kneaded with water into dough having a water content of 50˜60%, and extruded into noodles using the conventional apparatus of FIG. 1. The noodles were stored at −15 to −25° C. for 24 hours and then thawed at 5° C. for 12 hours. In order to separate strips thereof from each other, the noodles were scrubbed by hand at room temperature.

### EXAMPLE 2

### Sensory Test

The noodles prepared in Example 1 and Comparative Example 1 were cooked according to a general cooking recipe for making cold noodle dishes which were then tasted by 20 men and 20 women. An examination was made of the general taste of the dishes by measuring particular taste criteria including noodle strength, chewiness, and noodle thickness according to a five-point grade method. The results are given in Table 1, below.

TABLE 1

| | Chewy Texture | Smooth texture | Thickness Preference |
|---|---|---|---|
| Example 1 | 3.88 | 3.92 | 3.81 |
| C. Example 1 | 3.76 | 3.86 | 3.80 |

As shown in data of Table 1, the noodle manufactured according to the present invention was found to be superior in taste and food quality to that manufactured according to a conventional method. Also, the present invention has an advantage over the conventional method in terms of cost and time.

When manufactured according to the present invention, as described hitherto, noodles do not experience puffing, weight variation, and agglomeration, and thus they can be produced in a continuous manner. Thus, the method according to the present invention does not need additional processes of freezing, thawing and manually scrubbing noodles after extrusion, and can manufacture a large quantity of noodles within a much shorter time period than can conventional methods. Also, the noodle manufactured according to the present invention exhibits the thin and chewy texture unique to fresh noodles. That is, the present invention can be applied to the mass production of cold noodles, thus enjoying the advantage of lowering the cost and improving the productivity.

Although the preferred embodiments of the present invention have been disclosed for illustrative purposes, those skilled in the art will appreciate that various modifications, additions and substitutions are possible. Accordingly, the modifications, additions and substitutions should be understood as falling within the scope and spirit of the invention.

What is claimed is:

1. A method of manufacturing cold noodles, comprising:
kneading a formulated material with water to afford dough having a water content of 30˜45%;
extruding the dough into individually separated strips through a die maintained at a low temperature using an extruder, said dough being heated to a temperature sufficiently high to induce gelatination therein by frictional force attributed to shearing force of the extruder; and
cutting the strips to a predetermined length and the packaging the strips.

2. The method as set forth in claim 1, wherein the die is 15 maintained at a temperature of 50° C. or lower and the dough is heated to a temperature range from 50 to 150° C.

3. The method as set forth in claim 1, wherein the formulated material is selected from a group consisting of wheat flour, buckwheat, starch, black rice powder, acorn powder, salts and combinations thereof.

4. An apparatus for manufacturing cold noodles, comprising:
a dough feeder including a plurality of carrying screws functioning to carry noodle dough; and
an extruder, including:
a cylindrical barrel, communicating through a passage with the dough feeder;
an extruding screw which rotates within the barrel, functioning to move forward the dough introduced through the passage within the barrel and to heat the dough to a temperature sufficiently high to induce gelatination therein by generating internal frictional force attributed to a shearing force of the extruding screw on the dough; and
an extruding die, maintained at the gelatination temperature and equipped with a plurality of holes for molding the dough into individually separated strips therethrough.

5. The apparatus as set forth in claim 4, wherein the extruding screw comprises a plurality of truncated conical screws having larger diameters at sides nearer an exit of the extruder, and a plurality of circular screws, installed near the exit within the barrel, for carrying the dough.

6. The apparatus as set forth in claim 4, wherein the extruding screw rotates at a speed from 50 to 150 rpm to heat the dough to a temperature range from 50° C. to 150° C.

7. The apparatus as set forth in claim 4, wherein each of the holes is 1 mm or less in diameter and the extruding die is maintained at 50° C.
